(19) United States
(12) Patent Application Publication
(10) Pub. No.: US 2012/0163622 A1
(43) Pub. Date: Jun. 28, 2012

(54) NOISE DETECTION AND REDUCTION IN AUDIO DEVICES

(75) Inventors: Muralidhar KARTHIK, Singapore (SG); Samsudin, Singapore (SG); Evelyn KURNIAWATI, Singapore (SG); Sapna GEORGE, Singapore (SG)

(73) Assignee: STMICROELECTRONICS ASIA PACIFIC PTE LTD, Singapore (SG)

(21) Appl. No.: 12/980,279

(22) Filed: Dec. 28, 2010

(51) Int. Cl. H04B 15/00; H04R 3/00

(52) U.S. Cl. 381/92; 381/94.1

(57) ABSTRACT

Methods and apparatuses for detection and reduction of wind noise in audio devices are disclosed. In an embodiment, a method includes acquiring and transforming the audio signals. Correlations from the transformed audio signals are computed. A cross correlation index is compared to a predetermined value to determine if a wind noise spectral content is present. In another embodiment, an apparatus includes an audio processing unit to receive non-decomposed audio signals, and an audio decomposition unit to receive the non-decomposed audio signals and to generate decomposed audio signals. A wind noise spectrum estimation unit receives non-decomposed audio signals and decomposed audio signals and identifies wind noise spectral components in at least one of the non-decomposed and decomposed audio signals. A wind noise spectrum reduction unit receives the wind noise spectral components and removes the wind noise spectral components from at least one of the non-decomposed and the decomposed audio signals.

### TECHNICAL FIELD

This disclosure relates generally to audio systems, methods and devices, and more particularly to the detection and reduction of wind noise in audio devices.

### BACKGROUND

In various audio devices using a single microphone or an array of microphones, wind noise may contribute to audio interference, due to local air turbulence around one or more microphone inlets in the audio device. Although wind screening devices that are positionable over a microphone inlet opening are in widespread use, these devices generally attenuate the sound pressure at the one or more inlet openings, resulting in reduced overall audio performance.

### SUMMARY

Methods and apparatuses for detection and reduction of wind noise in audio devices are disclosed. In an aspect, a method includes acquiring and transforming the audio signals. Correlations from the transformed audio signals are computed. A cross correlation index is compared to a predetermined value to determine if a wind noise spectral content is present. In another aspect, an apparatus includes an audio processing unit to receive non-decomposed audio signals, and an audio decomposition unit to receive the non-decomposed audio signals and to generate decomposed audio signals. A wind noise spectrum estimation unit receives non-decomposed audio signals and decomposed audio signals and identifies wind noise spectral components in at least one of the non-decomposed and decomposed audio signals. A wind noise spectrum reduction unit receives the wind noise spectral components and removes the wind noise spectral components from at least one of the non-decomposed and the decomposed audio signals.

### BRIEF DESCRIPTION OF THE DRAWINGS

Various embodiments are described in detail in the discussion below and with reference to the following drawings.

FIG. 1 is a flowchart that will be used to describe a method of detecting a wind noise spectral content in an audio signal, according to the various embodiments.

FIG. 2 is a flowchart that will be used to describe a method of detecting a wind noise spectral content in an audio signal, according to the various embodiments.

FIG. 3 is a flowchart that will be used to describe a method of detecting a wind noise spectral content in an audio signal, according to the various embodiments.

FIG. 4 is a flowchart that will be used to describe a method of detecting a wind noise spectral content in an audio signal, according to the various embodiments.

FIG. 5 is a flowchart that will be used to describe a method of detecting a wind noise spectral content in an audio signal, according to the various embodiments.

FIG. 6 is a diagrammatic block view of an apparatus for reducing a wind noise spectral content in an audio signal, according to the various embodiments.

FIG. 7 is a diagrammatic block view of an apparatus for reducing a wind noise spectral content in an audio signal, according to the various embodiments.

FIG. 8 is a diagrammatic block view of an apparatus for reducing a wind noise spectral content in an audio signal, according to the various embodiments.

FIG. 9 is a diagrammatic block view of an apparatus for reducing a wind noise spectral content in an audio signal, according to the various embodiments.

FIG. 10 is a diagrammatic block view of an apparatus for reducing a wind noise spectral content in an audio signal, according to the various embodiments.

FIG. 11 is a diagrammatic block view of an apparatus for reducing a noise spectral content in an audio signal, according to the various embodiments.

FIG. 12 is a diagrammatic block view of an apparatus for subtracting a noise spectral content from an audio signal, according to the various embodiments.

FIG. 13 is a flowchart that will be used to describe a method of spectral subtraction, according to the various embodiments.

### DETAILED DESCRIPTION

Audio systems, methods and devices configured to reduce wind noise effects are disclosed. Briefly, and in general terms, wind noise may constitute a problem in a variety of audio devices, such as mobile phones, hearing aids and sound recording devices. Disturbances resulting from turbulent air flow proximate to the one or more microphones coupled to the audio device may generate noise that may cause degradation in the audio signal. In particular, audio devices that include more than one microphone may have an elevated susceptibility to wind noise, since the effects of wind noise are generally uncorrelated. The various embodiments may also find application in reducing the effects of still other sources of noise in audio signals, such as noise stemming from background sources other than wind, self-generated electronic noise, and self-generated electromechanical noise due to the movement of an electromechanical device configured to translate a lens focusing apparatus.

In accordance with the various embodiments, a method of detecting the presence of wind noise spectral content in an audio signal will be described. In the discussion that follows, reference may be made to an array of four microphones that may be positioned on an audio device. It is understood in the following discussion that the microphone array may include fewer than four microphones, or even more than four microphones. Further, in the discussion that follows, it is understood that the methods and apparatuses may be executed using hardware, software and/or firmware elements, or any combination of hardware, software and/or firmware elements. Accordingly, the various embodiments are not to be interpreted as depending from any particular implementing form.

A time domain response for each of four microphones in a microphone array may be expressed as:

r₁(n;blknum); (1)

r₂(n;blknum); (2)

r₃(n;blknum); (3)

r₄(n;blknum); (4)

where the parameter n indicates an index to access the sample points in the time-domain block. The time domain signals as expressed in expressions (1) through (4) may be subjected to a window function, such as a Hamming or a Hanning window function in order to avoid spectral leakage, as well as other undesired effects. Still other window functions may also be employed, such as, for example, a rectangular or a cosine window function.

The time domain signals as expressed in expressions (1) through (4) may be decomposed into discrete frequency components by performing a discrete Fourier transform (DFT) on the time domain signals in expressions (1) through (4). In accordance with the various embodiments, the DFT may include any one of the algorithms collectively known as the Fast Fourier Transform (FFT). The frequency distributions corresponding to the time domain signals may therefore be represented by:

f₁(f;blknum)=F(r₁(n;blknum)); (5)

f₂(f;blknum)=F(r₂(n;blknum)); (6)

f₃(f;blknum)=F(r₃(n;blknum)); (7)

f₄(f;blknum)=F(r₄(n;blknum)); (8)

where F is a generalized DFT operator, which may represent the application of the FFT algorithm to the time domain signals in expressions (1) through (4). Autocorrelations may also be generated that may represent an instantaneous power from each of the respective microphones in the microphone array (for selected frequency bins):

f₁₁(f;blknum)=αf₁₁(f;blknum−1)+(1−α)f₁(f;blknum)f₁*(f;blknum); (9)

f₂₂(f;blknum)=αf₂₂(f;blknum−1)+(1−α)f₂(f;blknum)f₂*(f;blknum); (10)

f₃₃(f;blknum)=αf₃₃(f;blknum−1)+(1−α)f₃(f;blknum)f₃*(f;blknum); (11)

f₄₄(f;blknum)=αf₄₄(f;blknum−1)+(1−α)f₄(f;blknum)f₄*(f;blknum). (12)

In the foregoing expressions (9) through (12), the terms f₁*, f₂*, f₃* and f₄* represent conjugate functions of the transforms f₁, f₂, f₃ and f₄ in expressions (5) through (8), and α is a smoothing constant that ranges between zero and one. In the various embodiments, the smoothing constant α may be approximately 0.9, although other suitable values may also be used. Cross correlations may also be generated, which may be expressed as:

f₁₂(f;blknum)=αf₁₂(f;blknum−1)+(1−α)f₁(f;blknum)f₂*(f;blknum); (13)

f₁₃(f;blknum)=αf₁₃(f;blknum−1)+(1−α)f₁(f;blknum)f₃*(f;blknum); (14)

f₁₄(f;blknum)=αf₁₄(f;blknum−1)+(1−α)f₁(f;blknum)f₄*(f;blknum); (15)

f₂₃(f;blknum)=αf₂₃(f;blknum−1)+(1−α)f₂(f;blknum)f₃*(f;blknum); (16)

f₂₄(f;blknum)=αf₂₄(f;blknum−1)+(1−α)f₂(f;blknum)f₄*(f;blknum); (17)

f₂₃(f;blknum)=αf₂₃(f;blknum−1)+(1−α)f₂(f;blknum)f₃*(f;blknum); (18)

f₃₄(f;blknum)=αf₃₄(f;blknum−1)+(1−α)f₃(f;blknum)f₄*(f;blknum). (19)

Based upon the autocorrelations presented in expressions (9) through (12)) and the cross correlations presented in expressions (13) through (19), a cross correlation index (CCI) may be defined as follows:

CCI(f;blknum)=[ABS(f₁₂(f;blknum))/√f₁₁(f;blknum)f₂₂(f;blknum)]+[ABS(f₁₃(f;blknum))/√f₁₁(f;blknum)f₃₃(f;blknum)]+[ABS(f₁₄(f;blknum))/√f₁₁(f;blknum)f₄₄(f;blknum)]+[ABS(f₂₃(f;blknum))/√f₂₂(f;blknum)f₃₃(f;blknum)]+[ABS(f₂₄(f;blknum))/√f₂₂(f;blknum)f₄₄(f;blknum)]+[ABS(f₃₄(f;blknum))/√f₃₃(f;blknum)f₄₄(f;blknum)] (20)

In the foregoing expression (20), the operator ABS represents the absolute value function, and the cross correlation index CCI may be evaluated for a selected frequency bin (e.g., a selected portion of the sampled spectrum) and for a selected block number, blknum. Since each of the terms in expression (20) may range in value between zero, which corresponds to uncorrelated signals, and one, which corresponds to completely correlated signals, expression (20) may have a magnitude that ranges in value between approximately zero and approximately six. Consequently, a relatively low magnitude value for the CCI generally reflects uncorrelated signals, and may indicate the presence of wind noise spectral content in an audio signal. Correspondingly, while a relatively higher magnitude value for the CCI generally reflects correlated signals, and may indicate that the audio signal may include wind noise spectral content is absent, or present only to a limited degree.

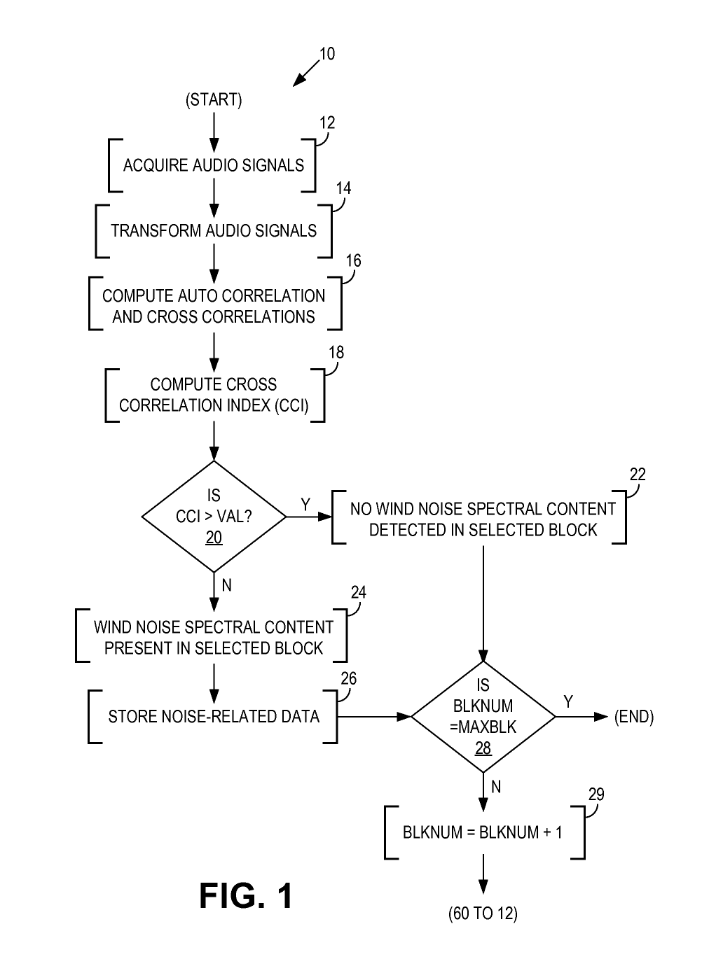

FIG. 1 is a flowchart that will be used to describe a method 10 of detecting a wind noise spectral content in an audio signal, according to the various embodiments. At 12, audio signals that may include a wind noise spectral content may be acquired by a microphone array. In accordance with the embodiments, the array may include four microphones, as shown in expressions (1) through (4) above, although the array may include greater than four microphones, or it may include fewer than four microphones. The acquired audio signals may extend over a predetermined period of time, and may be segregated into blocks having discrete block numbers (blknum), which may be processed sequentially by the method 12. The acquired audio signals may also be multiplied by a selected window function, such as a Hanning window function, although other window functions may also be used.

At 14, the audio signals acquired at 12 may transformed using a DFT algorithm to generate frequency distributions corresponding to the audio signals, as shown in expressions (5) through (8) above. In an embodiment, one of the Fast Fourier Transform algorithms may be employed. Accordingly, the frequency distributions may include frequency bins of a predetermined frequency range, for example, each bin may be approximately about 16 Hz, although the bins may include any suitable frequency range. At 16, autocorrelations and cross correlations may be computed, in accordance with the expressions (9) through (19) above, and the Cross Correlation Index (CCI) may be computed, as shown in expression (20) above, at 18.

At decision 20, the CCI may be compared to a predetermined value VAL to determine if wind noise spectral content is present. Since the CCI may range between approximately zero and approximately six, the predetermined value VAL may include any value between approximately zero and approximately six. For example, VAL may be selected to be approximately 3.5, although other values that are either greater than 3.5 or less than 3.5 may also be used. In any case, if the CCI computed at 18 is greater that the selected value for VAL, then the method 10 determines that wind noise spectral content is not present in the selected block of the acquired audio signals, as shown at 22. Alternatively, if CCI is determined to be less than the selected value for VAL, then the method 12 determines that wind noise spectral content is present in the selected block, at 24, and the pertinent data, such as the block number (blknum), or other pertinent data, may be stored, as shown at 26. At decision 28, the method 10 determines whether all blocks have been processed by the method 10, by comparing the blknum to a fixed value that expresses the maximum number of blocks to be processed (MAXBLK). If all blocks have been processed, then the method 10 ends. Otherwise, at 29, blknum is incremented, and the method 10 returns to 12, and acquires another audio signal block.

In accordance with the various embodiments, another method of detecting the presence of wind noise spectral content in an audio signal will now be described. Briefly, and in general terms, the method includes calculating a power in a low frequency region of the audio signals, and does not require the intermediate computation of the various autocorrelations and cross correlations, as described in the method disclosed above. The power in the low frequency audio region may be expressed as follows:

LFP(blknum)=α[LFP(blknum−1)]+(1−α)[SUM[ABS(f₁(0,blknum) . . . ABSf₁(LFNUM,blknum)]/[SUM[ABS(f₁(0,blknum) . . . ABSf₁(BLKLEN/2−1,blknum)] (21)

In the foregoing expression (21), SUM represents a summation operator, which is operable to form a sum of all of the arguments. Accordingly, in expression (21), the suitably transformed time domain signals are summed over all frequency bins in a selected low frequency range. For example, in the numerator portion of expression (21), the transformed time domain signals may be summed from the zero frequency bin to a selected upper limit, LFNUM. In the various embodiments, the LFNUM may be approximately 40, so that if each frequency bin is approximately about 16 Hz, the expression (21) is summed for all frequency bins up to approximately 640 Hz, although other values for LFNUM and other frequency bin values may also be used. In the denominator portion of expression (21), the suitably transformed time domain signals are summed from the zero frequency bin to an upper limit (BLKLEN/2-1), which entails most of the sampled frequency bins. In expression (21), α is the smoothing constant as previously described, and may have a value of approximately 0.9, although other suitable values may also be used.

If the computed value for LFP(blknum) is greater than a predetermined threshold value, then wind noise spectral content is absent from the audio signals. Correspondingly, if the computed value for LFP(blknum) is less than, or even equal to the selected threshold value, then wind noise spectral content is present in the audio signals. In accordance with the various embodiments, a value for the threshold value may be greater than 0.1, and less than 0.9. In another of the various embodiments, the selected threshold value ranges between approximately 0.5 and approximately 0.7.

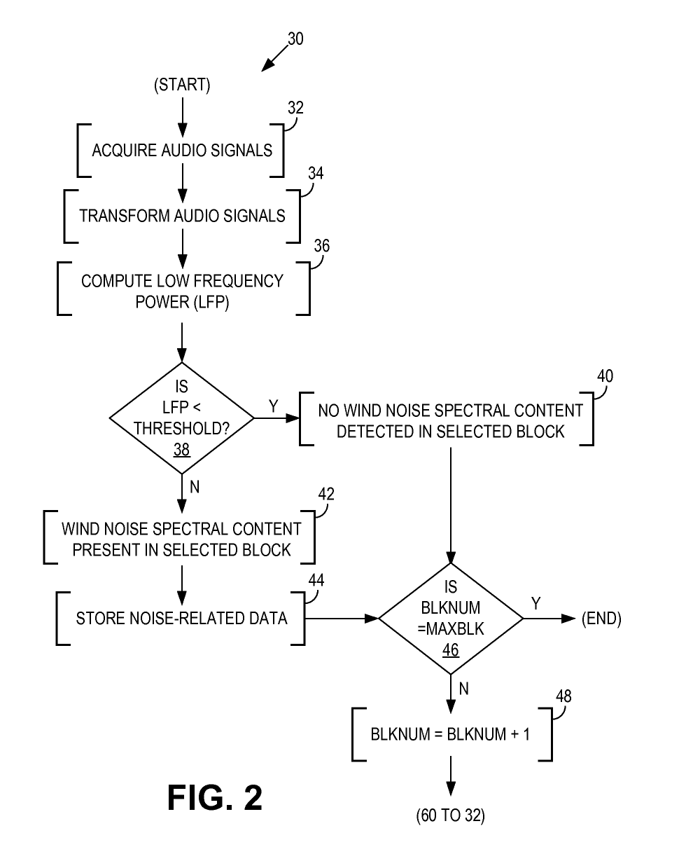

FIG. 2 is a flowchart that will be used to describe a method 30 of detecting a wind noise spectral content in an audio signal, according to the various embodiments. At 32, audio signals that may include wind noise spectral content may be acquired by a selected microphone. The acquired audio signals may be segregated into blocks having discrete block numbers (blknum), which may again be processed sequentially by the method 30. The acquired audio signals may also be multiplied by a selected window function, such as a Hanning window function.

At 34, the audio signals acquired at 32 may transformed using a DFT algorithm, such as one of the Fast Fourier Transform (FFT) algorithms, as discussed in greater detail above. At 36, the low frequency power LFP(blknum) may be computed, in accordance with the foregoing expression (21). At decision 38, the calculated LFP may be compared to the selected threshold value. Accordingly, if LFP is less than the selected threshold value, then no wind spectral content is detected in the selected block, at 40. Otherwise, if the calculated LFP is greater than the selected threshold value, at 42, wind noise spectral content is detected in the selected block. At 44, the noise-related data may be stored for the selected block. At 46, the method 30 determines whether all blocks have been processed by comparing the blknum to MAXBLK. If all blocks have been processed, then the method 30 ends. Otherwise, blknum is incremented at 48, and the method 30 returns to 32, and acquires another audio signal block.

With reference still to FIG. 2, it is understood that that the method 30 may be performed using audio signals from any one microphone in an array of microphones. Moreover, the method 30 may be successively performed for each time domain response from a microphone array, so that wind noise spectral content may be detected in each time domain response.

Still another method of detecting the presence of wind noise spectral content in an audio signal may now be described. The presently disclosed method includes arranging the suitably transformed time domain signals time into an array A, so that:

A(f,blknum)=[LOG(fᵢ(f,blknum))] (22)

Where LOG is a logarithmic operator that operates on the transformed time domain signals fᵢ(f, blknum). A slope may be calculated by applying a LINREG operator to the array A. The LINREG operator performs a linear regression on the elements of the array A, and returns a value for SLOPE, as follows:

SLOPE(blknum)=LINREG(A) (23)

The magnitude of SLOPE obtained from expression (23) may then be compared to a selected threshold value, so that if SLOPE<threshold, then the audio signal includes wind noise spectral content. In the various embodiments, a suitable threshold value may be within a range of values between approximately one and negative one. In another of the various embodiments, the threshold value may be approximately zero. In still another of the various embodiments, the threshold may be approximately −0.02.

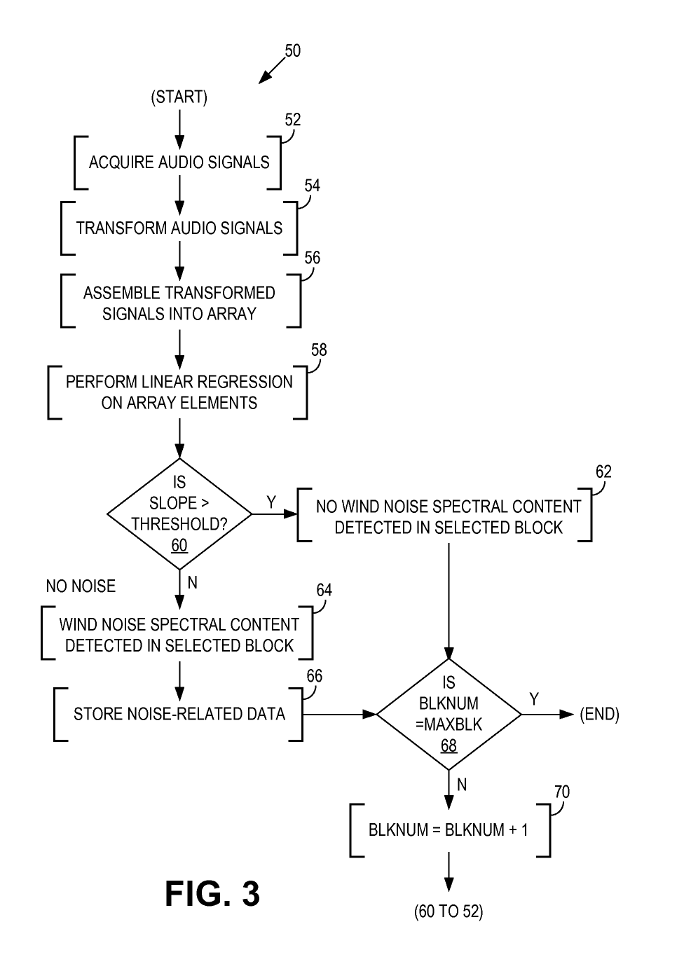

FIG. 3 is a flowchart that will be used to describe a method 50 of detecting a wind noise spectral content in an audio signal, according to the various embodiments. At 52, audio signals that may include wind noise spectral content may be acquired, and may also be multiplied by a selected window function. The acquired audio signals may be segregated into blocks having discrete block numbers (blknum), which may again be processed sequentially by the method 50.

At 54, the acquired audio signals may be transformed using a DFT algorithm, such as one of the Fast Fourier Transform (FFT) algorithms. At 56, the transformed signals may be arranged into an array. When the transformed signals are arranged in the array, the logarithm of each of the elements may be taken, as shown in expression (22) above. At 58, a linear regression on the array elements may be performed, as shown in expression (23), to generate a slope value. At decision 60, the slope value generated at 58 may be compared to a predetermined threshold value. At 62, if the slope value is greater than the threshold value, then the method 50 determines that there is no wind noise spectral content in the audio signals. If the slope value is less than the threshold value, then the method 50 determines that wind noise spectral content is present in the audio signals, at 64. At 66, the noise-related data may be stored. At 68, the method 50 determines whether all blocks have been processed by comparing the blknum to MAXBLK. If all blocks have been processed, then the method 50 ends. Otherwise, blknum is incremented at 70, and the method 50 returns to 52, and acquires another audio signal block.

Still yet another method of detecting the presence of wind noise spectral content in an audio signal is described below. The disclosed method includes calculating a Cross Correlation Index (CCI), as shown in expression (20), for a selected number of the frequency bins. The CCI values may then be averaged to yield an average value (AVAL) that may be compared to a predetermined threshold value to determine if wind noise spectral content is present in an audio signal. Accordingly, AVAL may be expressed as:

AVAL=AVG(CCI(0,blknum) . . . CCI(LFNUM,blknum)) (24)

Where AVG is an operator that performs arithmetic averaging on the arguments in expression (24), and LFNUM is a parameter that expresses a maximum bin number to be included in the averaging. The value for AVAL may be compared to a predetermined threshold value, so that if AVAL<threshold, wind noise spectral content may be present in the audio signals.

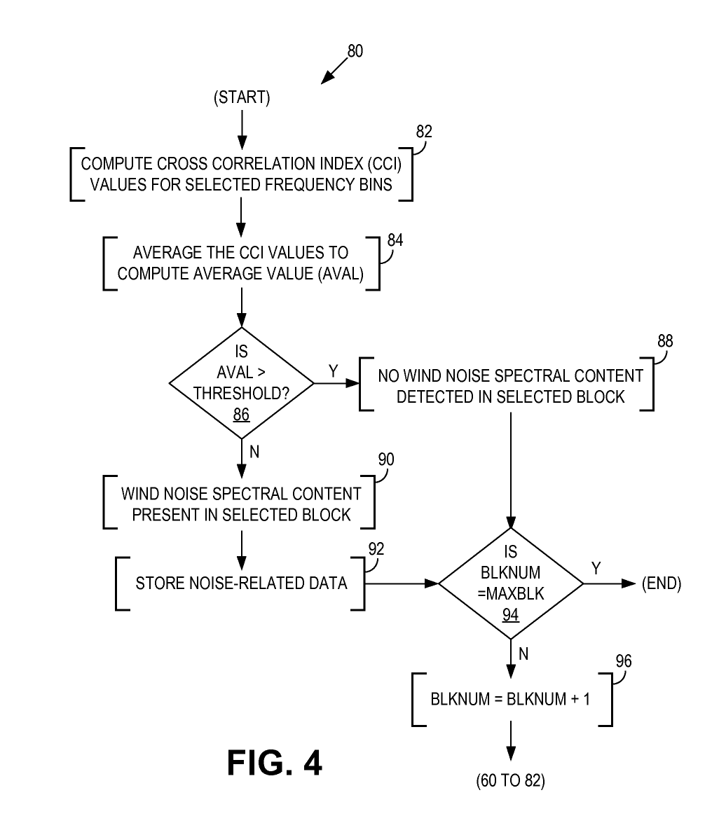

FIG. 4 is a flowchart that will be used to describe a method 80 of detecting a wind noise spectral content in an audio signal, according to the various embodiments. At 82, cross correlation index (CCI) values may be computed for selected frequency bins. For example, the CCI may be computed for frequency bins extending from 0 to approximately 60, so that the frequency range of interest extends from approximately zero Hz to approximately 1 kHz, although any suitable range of frequency bins may also be used. At 84, the selected CCI may be averaged, so that the AVAL value may be generated. At 86, the magnitude of AVAL may be compared to a selected threshold value. Accordingly, if the magnitude of AVAL is greater than the selected threshold value, no wind noise spectral content is detected in the selected block, as shown at 88. Otherwise, if AVAL is not greater than the threshold value, the method 80 determines that wind noise spectral content is present in the selected block, as shown at 90. At 92, the detected wind noise spectral content may then be stored. At decision 46, the method 80 determines if all blocks have been processed. If not all of the blocks have been processed, then blknum is incremented at 96, and the method 80 returns to 82. Otherwise, if all blocks have been processed, the method 80 ends.

In another method, a combination of the foregoing methods may be employed to determine if audio signals include wind noise spectral content. As a preliminary matter, the audio signals, generally referred to as A-format signals, may be decomposed (or processed) into B-format signals having non-directional and directional components that may generally include an omnidirectional component W, and X, Y and Z directional components. Accordingly, the following definitions may be made:

AVG₁=AVG(LFP(a(1)), LFP(a(2)) . . . LFP(a(n));

AVG₂=AVG(LFP(b(1)), LFP(b(2)) . . . LFP(b(n));

AVG₃=AVG(SLOPE a(1), SLOPE a(2) . . . SLOPE a(n));

AVG₄=AVG(SLOPE b(1), SLOPE b(2) . . . SLOPE b(n)); and

AVG₅=AVG(CCI)

Where LFP may be calculated according to expression (21) presented above, the SLOPE may be calculated according to expression (23) presented above, and the CCI may be calculated according to expression (20). In the foregoing, a(i) represents A-format signals corresponding to the discrete frequency bins, and b(i) includes B-format signals derived from the A-format signals. Briefly, and in general terms, audio signals (e.g., A-format audio signals) received by an audio device may be decomposed to yield B-format signals that exhibit both non-directional and directional characteristics. For example, the A-format signals may be decomposed and processed to form the B-format signals having a W component, which is a generally non-directional monaural component, and up to three directional components, generally referred to as the X, Y and Z B-format components. The foregoing definitions may be combined to yield a parameter COMB:

COMB=C₁AVG₁+C₂AVG₂+C₃AVG₃+C₄AVG₄+C₅AVG₅ (25)

Where C₁, C₂, C₃, C₄ and C₅ are constants that may be selected to provide suitable weighting in expression (25). In order to determine if a wind noise spectral content may be present in the audio signals, the parameter COMB may be compared to a threshold value, so that if COMB<threshold, then wind noise spectral content may be present in the audio signals. Although expression (25) utilizes the LFP, SLOPE and CCI in evaluating COMB, it is understood that in other embodiments, the LFP and the SLOPE may be used, or alternatively, the LFP and CCI, or the SLOPE and the CCI may be used.

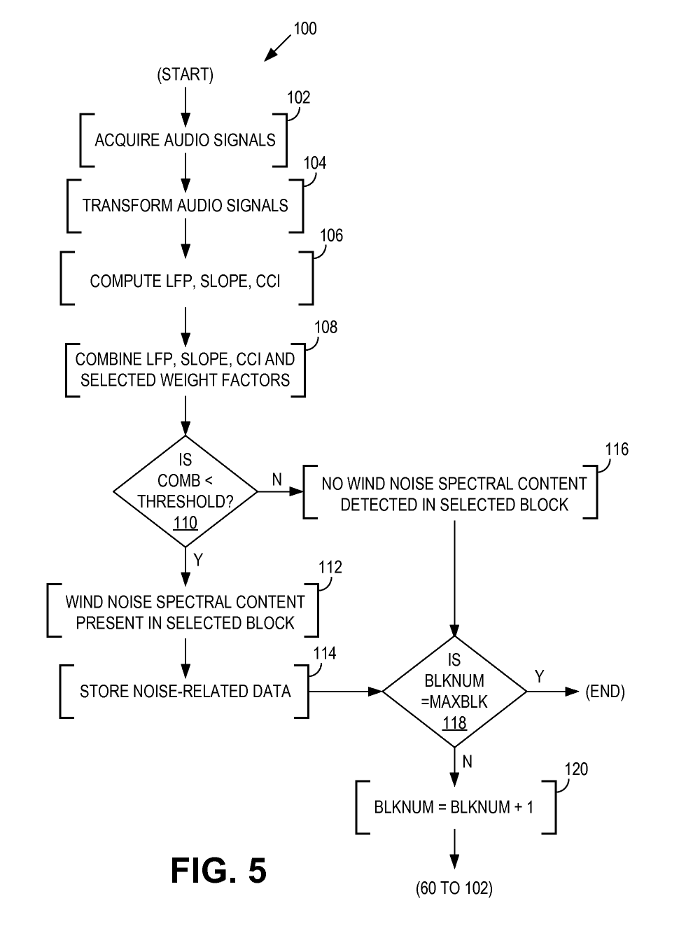

FIG. 5 is a flowchart that will be used to describe a method 100 of detecting a wind noise spectral content in an audio signal, according to the various embodiments. At 102, audio signals that may include wind noise spectral content may be acquired. At 104, the acquired audio signals may be transformed, as described above, and may further be processed, so that A-format and B-format signals are obtained. At 106, the LFP, the SLOPE and the CCI may be computed. At 108, the LFP, the SLOPE and the CCI may be combined with selected weight factors so that COMB may be generated, as shown in expression (25) above. At decision 110, if COMB is less than a selected threshold value, then the audio signals include wind noise spectral content, as shown at 112. Accordingly, the wind noise-related data may be appropriately stored, as shown at 114. Alternatively, if COMB is greater than the selected threshold value, then the audio signals do not include wind noise spectral content, as shown at 116. At decision 118, the method 100 determines if all blocks have been processed, and if so, the method 100 ends. Alternatively, blknum is incremented at 120, and the method 100 returns to 102.

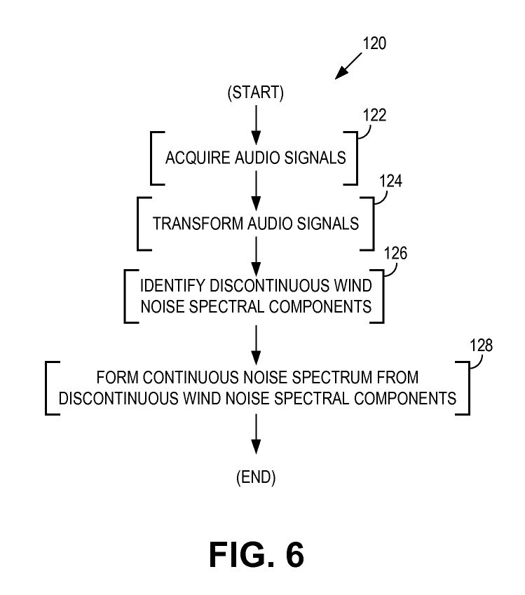

FIG. 6 is a flowchart that will be used to describe a method 120 of detecting a wind noise spectral content in an audio signal, according to the various embodiments. At 122, audio signals that may include wind noise spectral content may be acquired. At 124, the acquired audio signals may be transformed, as described above, and may further be processed, so that A-format and B-format signals may be obtained. Using a selected one of the B-format signals, the wind noise spectral components may be identified, as shown at 126. For example, the method 10 of FIG. 1 may be used, where cross correlation index values (CCI) are calculated for a plurality of frequency bins. At 128, a continuous noise spectrum may be formed from the discontinuous portions found at 126. Accordingly, any suitable curve-fitting algorithm may be employed including a least-squares polynomial regression algorithm, a spline algorithm using piecewise-continuous polynomials. Alternatively, other suitable curve-fitting methods may also be used.

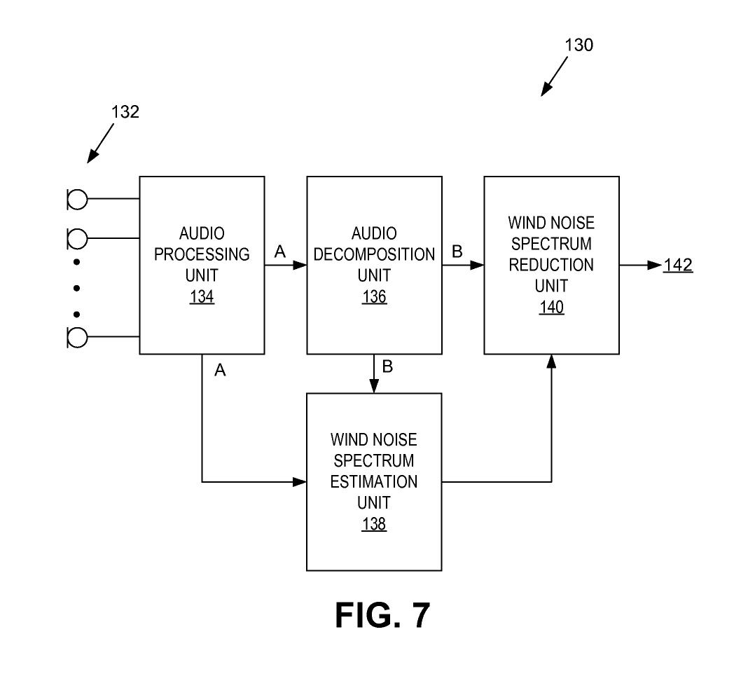

FIG. 7 is a diagrammatic block view of an apparatus 140 for reducing a wind noise spectral content in an audio signal, according to the various embodiments. The apparatus 130 includes a microphone array 132 that may include four microphones, although the array 132 may include more than four microphones, or as few as a single microphone. Although the microphones may include any suitable transducer configured to convert acoustic waves into electrical signals, in the various embodiments, the microphones may include, for example, electret condenser microphones.

The microphone array 132 may be coupled to an audio processing unit 134 that may be configured to provide power to the array 132, and to receive and amplify signals received from the array 132. The audio processing unit 124 may also be configured to perform other signal processing functions, such as analog-to-digital (ND) conversion of the analog signals received from the array 132 and provide storage for analog or digital signals. The audio processing unit 124 may also be configured to provide level and data compression of the received signals. Still other audio enhancements may be provided by the audio processing unit 124, including equalization and filtering, or other audio enhancements.

The audio processing unit 134 may be coupled to an audio decomposition unit 136. Briefly, the audio decomposition unit 136 may be configured to receive non-decomposed audio signals (e.g., A-format audio signals) from the audio processing unit 134, and decompose the received A-format audio signals into B-format signals (e.g., W, X, Y and Z components) that exhibit both non-directional and directional characteristics.

Still referring to FIG. 7, the audio decomposition unit 136 may be coupled to a wind noise spectrum estimation unit 138 that is configured to receive A-format signals from the audio processing unit 134, and to receive B-format signals from the audio decomposition unit 136. The wind noise spectrum estimation unit 138 may be further configured to execute any of the foregoing methods shown in FIG. 1 through FIG. 5, and described in detail above.

The apparatus 130 also includes a wind noise spectrum reduction unit 140 that is configured to receive B-format signals from the audio decomposition unit 136, and also coupled to the wind noise spectrum estimation unit 138. The wind noise spectrum reduction unit 140 may be configured to receive the wind noise spectral information generated by the wind noise spectrum estimation unit 138, and to remove the wind noise spectral effects from the B-format signals received by the wind noise spectrum reduction unit 140. Accordingly, the wind noise spectrum reduction unit 140 may generate an output 142 that has the wind noise spectral portion removed, as will be discussed in greater detail below.

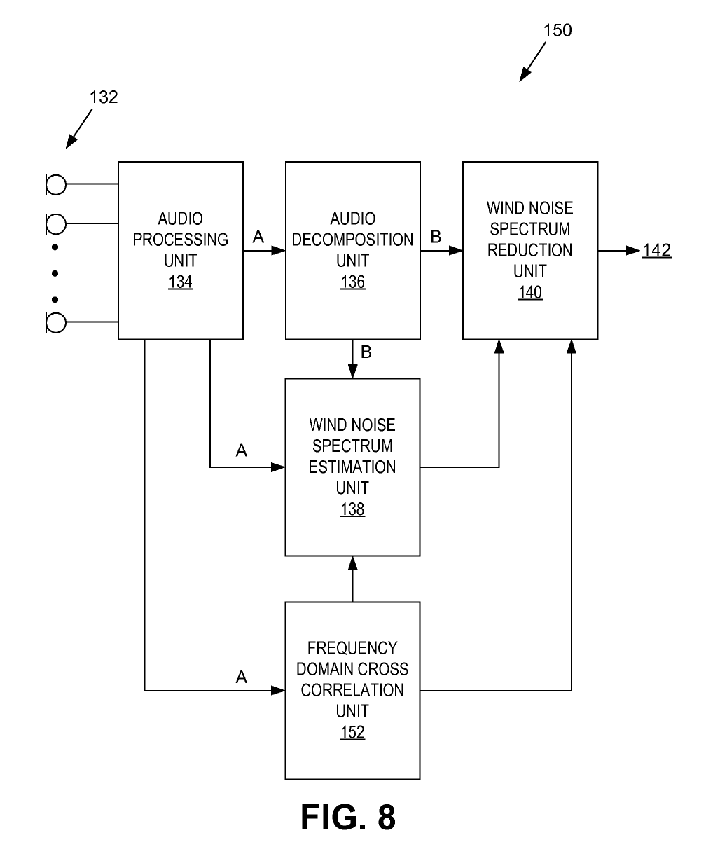

FIG. 8 is a diagrammatic block view of an apparatus 150 for reducing a wind noise spectral content in an audio signal, according to the various embodiments. The apparatus 150 may include the microphone array 132 that may be coupled to the audio processing unit 134. The audio processing unit 134 may be configured to provide power to the array 132, to receive and amplify signals received from the array 132, to provide analog-to-digital (ND) conversion, or other audio enhancements, as discussed earlier in detail. The A-format signals from the audio processing unit 134 may also be communicated to the wind noise spectrum estimation unit 138 for further processing. The audio decomposition unit 136 receives A-format signals from the audio processing unit 134 and generates B-format signals from the A-format signals, which may be communicated to the wind noise spectrum estimation unit 138, and to and to the wind noise spectrum reduction unit 140, as previously described.

The apparatus 150 may also include a frequency domain cross correlation unit 152 that is operable to transform the A-format signals, and to form autocorrelations and cross correlations based upon the transformed values. In addition, the frequency domain cross correlation unit 152 may be configured to generate the cross correlation index (CCI) and to compare the CCI to a threshold value, as discussed in detail above.

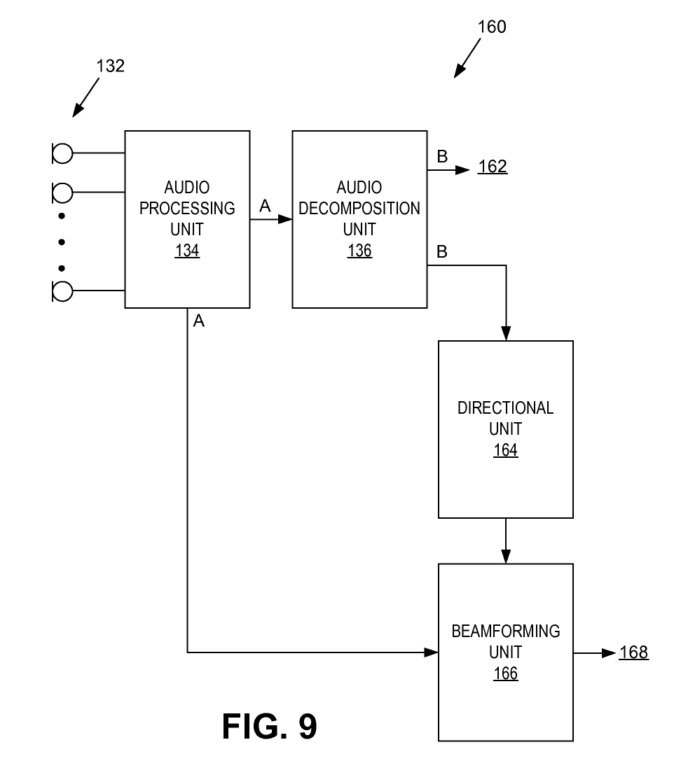

FIG. 9 is a diagrammatic block view of an apparatus 160 for reducing a wind noise spectral content in an audio signal, according to the various embodiments. The apparatus 160 may include the microphone array 132, which may be coupled to the audio processing unit 134, which has been described in detail earlier. The A-format signals from the audio processing unit 134 may also be communicated to the audio decomposition unit 136 to generate B-format signals from the A-format signals. The generated B-format signals may be directed to an output 162, so that the B-format signals may be directed to other stages. The B-format signals from the audio decomposition unit 136 may also be directed to a directional unit 164 that may be configured to receive the B-format components and to determine a principal direction of arrival for the wind noise relative to the orientation of the microphone array 132. The principal direction of arrival information may be communicated to a beamforming unit 166 for further processing. Briefly, and in general terms, the beamforming unit 166 may be configured to receive A-format information from the audio processing unit 134, and to process the A-format information and the principal direction of arrival information so that the acoustic waves received by the microphone array 132 appear to be received from a preferential direction that eliminates the influence of the wind noise on the microphone array 132. For example, the preferential direction may be approximately aligned with a null direction for the wind noise. Accordingly, an output 168 from the beamforming unit 166 may exhibit a substantially-reduced wind noise spectrum component.

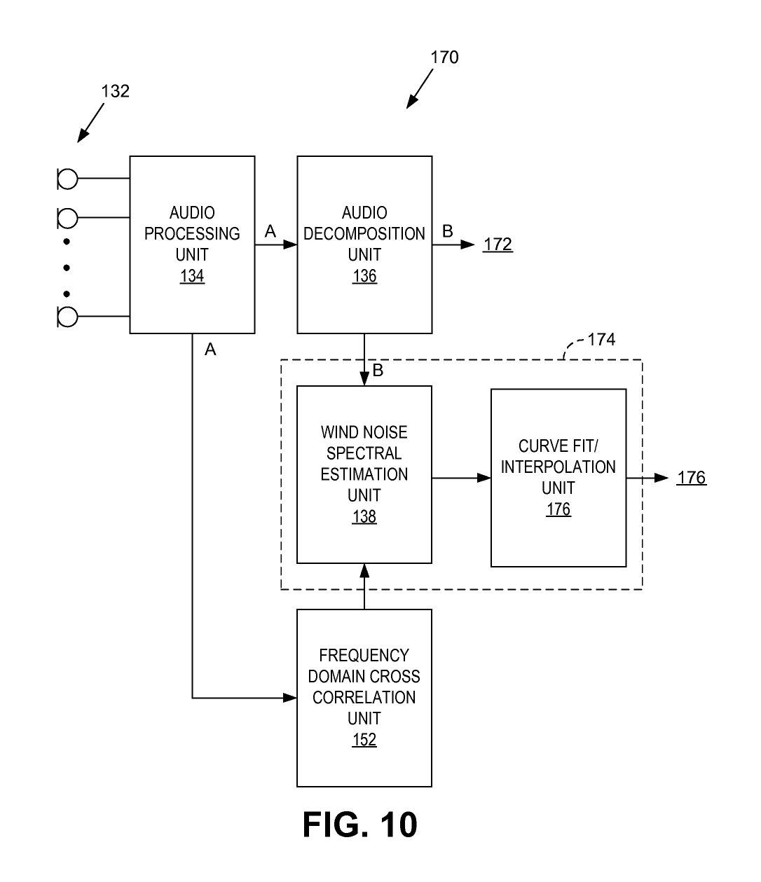

FIG. 10 is a diagrammatic block view of an apparatus 170 for reducing a wind noise spectral content in an audio signal, according to the various embodiments. The apparatus 170 may include the microphone array 132 which may provide audio signals to the audio processing unit 134. The audio decomposition unit 136 may generate B-format signals from the A-format signals, as discussed earlier. The generated B-format signals may be directed to an output 172, so that the B-format signals may be directed to other stages. The B-format signals from the audio decomposition unit 136 may also be directed to a wind noise spectral estimation unit 174, which will be described in greater detail below.

The apparatus 170 may also include the frequency domain cross correlation unit 152, which was discussed earlier in conjunction with FIG. 8. Briefly, the frequency domain cross correlation unit 152 may be configured to form autocorrelations and cross correlations based upon the transformed values, and to generate the cross correlation index (CCI), as discussed earlier. The CCI may then be provided to the wind noise spectral estimation unit 174.

The wind noise spectral estimation unit 174 may include the wind noise spectral estimation unit 138, as also discussed earlier in connection with FIG. 7. The wind noise spectral estimation unit 138 may be coupled to a curve fit/interpolation unit 174 that may be configured to provide a curve fit to discontinuous portions of the wind noise spectral content identified by the frequency domain cross correlation unit 152, so that a continuous wind noise spectrum may be generated, as discussed in conjunction with FIG. 6. The curve fit/interpolation unit 174 may also be configured to perform interpolation at selected locations along the continuous wind noise spectrum. The curve fit/interpolation unit 174 may also be configured to provide an output 176 that may be communicated to other stages.

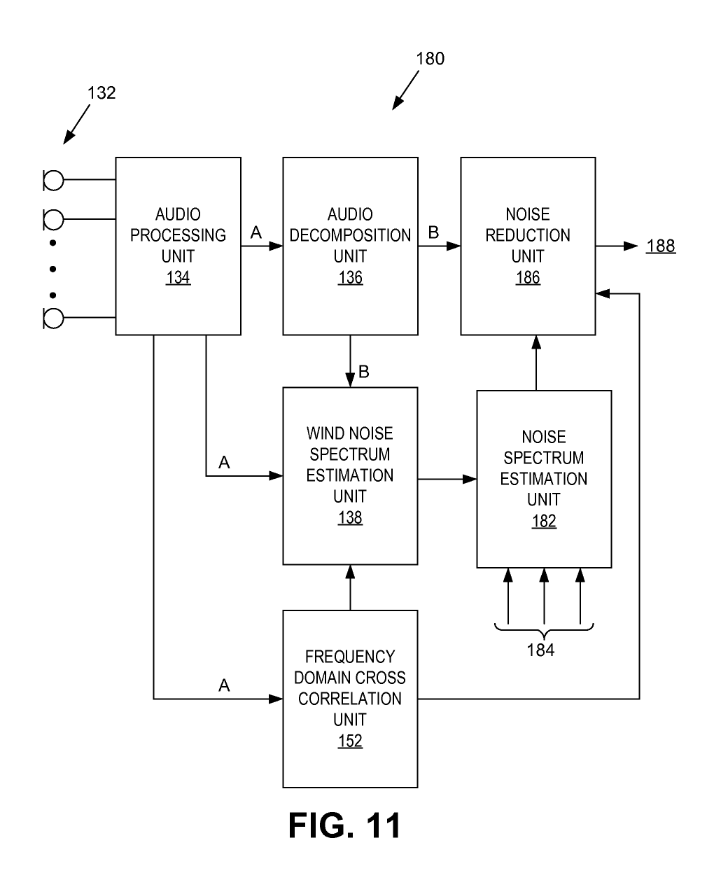

FIG. 11 is a diagrammatic block view of an apparatus 180 for reducing a noise spectral content in an audio signal, according to the various embodiments. As a preliminary matter, it will be understood that an audio device may be adversely affected by noise sources other than wind noise effects on the microphone array 132. The audio device may be adversely affected by other sources of noise, such as extraneous background noise that may be detected by the array 132, or it may be due to internal sources of noise, such as electronic noise. Still other noise sources may affect the audio device, such as electromechanical noise generated by an operative portion of the audio device, such as, for example, a motor drive mechanism associated with a camera zoom lens or a lens focusing device, if the audio device is so equipped. Since still other noise sources may affect the audio device, the various embodiments are not to be interpreted as limited to the noise sources described herein.

Referring still to FIG. 11, the apparatus 180 may include the microphone array 132 that is coupled to the audio processing unit 134. A-format signals generated by the audio processing unit 134 may be received by the audio decomposition unit 136, so that B-format signals may be generated. The audio processing unit 134 and the audio decomposition unit 136 may be coupled to the wind noise spectrum estimation unit 138, so that A-format signals and B-format signals may be received by the wind noise spectrum estimation unit 138. The frequency domain cross correlation unit 152 may also receive A-format signals from the audio processing unit 134 so that the cross correlation index (CCI) may be generated. The frequency domain cross correlation unit 152 may then communicate the CCI to the wind noise spectrum estimation unit 138.

A noise spectrum estimation unit 182 may be configured to receive input signals 184 from a plurality of other spectrum estimation units that are specifically tailored to process and estimate signals received from these sources. For example, the input signals 184 may receive signals from an electronic noise spectrum estimation unit, a motor drive mechanism noise spectrum estimation unit, a background noise spectrum estimation unit, although other input signals 184 may be dedicated to other noise spectrum estimation units, if desired. The noise spectrum estimation unit 182 may therefore be configured to process the input signals 184 and the wind noise spectrum estimation received from the wind noise spectrum estimation unit 138. The noise spectrum estimation unit 182 may be coupled to a noise reduction unit 186 that may be configured to substantially remove the effects of the noise sources, so that an output 188 may communicate audio signals that are not affected by the noise sources.

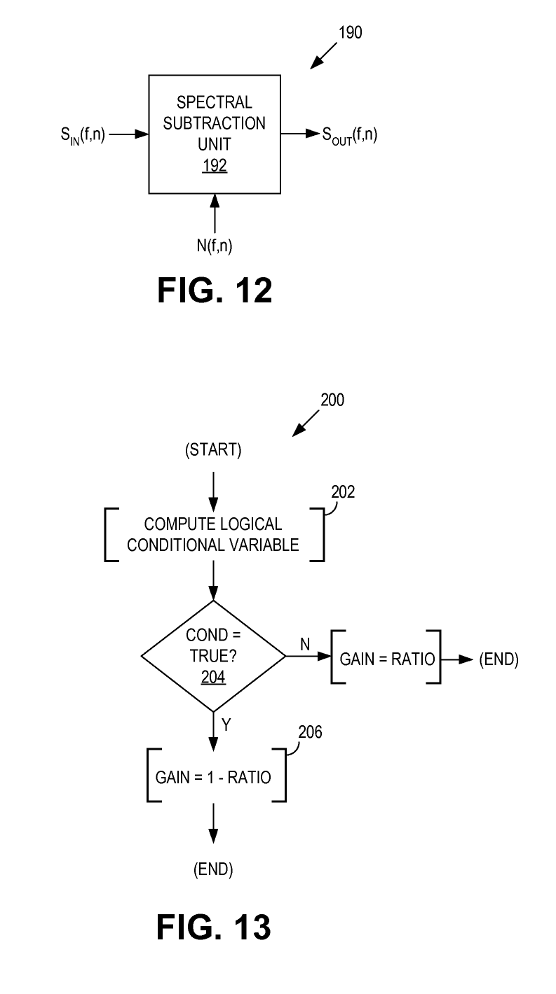

FIG. 12 is a diagrammatic block view of an apparatus 190 for subtracting a noise spectral content from an audio signal, according to the various embodiments. The apparatus 190 may be incorporated into the wind noise spectrum reduction unit, as shown in FIGS. 7 and 8, and the noise reduction unit shown in FIG. 11. The apparatus 190 may also include a spectral subtraction unit 192 that may be configured to apply a gain factor to an input spectrum Sᵢₙ(f, n) that includes the wind noise spectral components, so that an output spectrum Sₒᵤₜ(f,n) may be generated having the wind noise spectral components substantially removed. The spectral subtraction unit 192 may further be configured to receive a wind noise spectral estimate N(f,n), which may be generated by the wind noise spectrum estimation unit 138, as shown in FIGS. 7 and 8, and also in FIGS. 10 and 11.

One suitable form for the gain factor may be expressed by G(f;n)=1−(ABS(N(f;n))/ABS(Sᵢₙ(f;n)), provided that ABS(Sᵢₙ(f;n))−C₆ ABS(N(f;n))≧C₇ ABS (N(f;n)) where C₆ and C₇ are suitably selected constants. Another suitable form for the gain factor may include G(f;n)=(ABS(N(f;n))/ABS(Sᵢₙ(f;n)), when ABS(Sᵢₙ(f;n))−C₆ ABS(N(f;n))<C₇ ABS (N(f;n)). In the various embodiments, the constant C₆ may range between approximately zero and one. In still other embodiments, the constant C₆ may be approximately 0.1. The constant C₇ may also range between approximately zero and one, and may also range between approximately 0.3 and 0.4.

FIG. 13 is a flowchart that will be used to describe a method 200 of spectral subtraction, according to the various embodiments. In the method 200 that follows, the cross correlation index (CCI), as shown in expression (20) and discussed in detail above may be used to compute the spectral gains, as previously described. At 202, a logical conditional variable may be calculated, which may be expressed as follows:

COND=(ABS(S(f;n))−C₈ ABS(N(f;n))≧C₉ ABS N(f;n)) ‘OR’((f<f_{L}) ‘AND’ maskCC(f;n)=1), where S(f;n) and N(f;n) are the input spectrum and the wind noise estimate, respectively, and ‘OR’ and ‘AND’ are Boolean logical operators. MaskCC(f;n) is a variable mask, which will be described in greater detail below. The constant C₈ may be greater than, or equal to one, but in the various embodiments, may range between approximately three and approximately six. The constant C₉ may range between zero and one, but in the various embodiments, may range between approximately 0.005 and approximately 0.1. Since COND is a logical expression, it will yield a value of ‘TRUE’ of ‘FALSE’, which depends upon satisfaction of the inequality. At decision 204, a logical state of the logical conditional variable COND may be determined. If COND is “TRUE”, then the gain may be expressed as: G(f;n)=1−RATIO, where RATIO=(ABS(N(f;n))/ABS(Sᵢₙ(f;n)), as shown at 206. Otherwise, the method 200 proceeds to 208, where the gain may be expressed as: G(f;n)=RATIO.

The variable maskCC(f;n) may be calculated by first assigning a value to a temporary variable mask(f) according to a comparison between CCI(f;n) and a selected threshold value CCTH. Accordingly, if CCI(f;n)>CCTH, the temporary variable mask(f;n) may be assigned a value of one. Otherwise, mask(f;n) is set equal to zero. With values assigned to the temporary variable mask(f;n), and if any bin is characterizable as a signal bin, the immediate neighbors of the bins may also be included. Accordingly, if the temporary variable mask(f;n)>0, then mask(f−PKWDTH; n)= . . . mask(f+PKWDTH; n)=1, where PKWDTH is a selected parameter. Furthermore, if any frequency bin may be categorized as a signal bin, then the status may be maintained using a hangover method. Briefly, a hangover method may be implemented by selecting temporary variable mask(f;n) values that are greater than zero, and assigning maskCC(f;n)=HOVER, where HOVER is a selected hover block. If maskCC(f;n)>0., then the maskCC(f;n) may be decremented, so that maskCC(f;n)=maskCC(f;n)−1.

From the foregoing it will be appreciated that, although specific embodiments have been described herein for purposes of illustration, various modifications may be made without deviating from the spirit and scope of the disclosure. Furthermore, where an alternative is disclosed for a particular embodiment, this alternative may also apply to other embodiments even if not specifically stated.

1. A method of detecting a wind noise spectral content in audio signals, comprising:
acquiring the audio signals;
transforming the audio signals;
computing autocorrelations and cross correlations from the transformed audio signals;
computing a cross correlation index based upon the computed autocorrelations and cross correlations; and
if a magnitude of the cross correlation index is less than a predetermined value, determining that the wind noise spectral content is present in the audio signals.

2. The method of claim 1, wherein acquiring the audio signals comprises acquiring time-domain signals from a microphone array.

3. The method of claim 1, wherein acquiring the audio signals comprises multiplying the audio signals by a selected window function.

4. The method of claim 1, wherein transforming the audio signals comprises applying a Discrete Fourier Transform to the acquired audio signals.

5. The method of claim 1, wherein computing a cross correlation index comprises computing a value that ranges between approximately zero and approximately six.

6. The method of claim 1, wherein computing a cross correlation index comprises selecting a predetermined value that ranges between approximately two and approximately four.

7. The method of claim 6, wherein selecting a predetermined value that ranges between approximately two and approximately four comprises selecting a value of approximately three.

8. A method of detecting a wind noise spectral content in audio signals, comprising:
acquiring the audio signals;
transforming the audio signals;
based upon the transformed audio signals, computing a power in a low frequency region of the acquired signals;
comparing the computed low frequency power to a predetermined threshold value; and
if a magnitude of the computed low frequency power is greater than a predetermined value, determining that the wind noise spectral content is present in the audio signals.

9. The method of claim 8, wherein acquiring the audio signals comprises acquiring time-domain signals from a selected microphone in a microphone array.

10. The method of claim 8, wherein acquiring the audio signals comprises multiplying the audio signals by a selected window function.

11. The method of claim 8, wherein transforming the audio signals comprises applying a Discrete Fourier Transform to the acquired audio signals.

12. The method of claim 8, wherein comparing the computed low frequency power to a predetermined threshold value comprises comparing the computed low frequency power to a value that ranges between approximately 0.1 and approximately 0.9.

13. The method of claim 8, wherein comparing the computed low frequency power to a predetermined threshold value comprises comparing the computed low frequency power to a value that ranges between approximately 0.5 and approximately 0.7.

14. A method of detecting a wind noise spectral content in audio signals, comprising:
acquiring the audio signals;
transforming the audio signals;
assembling the transformed signals into an array;
performing a linear regression on the transformed signals in the array to generate a slope;
comparing the slope to a predetermined threshold value; and
if a magnitude of the slope is less than a predetermined value, determining that the wind noise spectral content is present in the audio signals.

15. The method of claim 14, wherein acquiring the audio signals comprises acquiring time-domain signals from a microphone array.

16. The method of claim 14, wherein transforming the audio signals comprises applying a Discrete Fourier Transform to the acquired audio signals.

17. The method of claim 14, wherein comparing the slope to a predetermined threshold value comprises comparing the slope to a value that ranges between approximately one and negative one.

18. The method of claim 14, wherein comparing the slope to a predetermined threshold value comprises comparing the slope to a value that is approximately zero.

19. A method of detecting a wind noise spectral content in audio signals, comprising:
acquiring the audio signals;
transforming the audio signals;
selecting frequency bins corresponding to a predetermined frequency range for the acquired audio signals;
computing autocorrelations and cross correlations for the predetermined frequency bins;
computing cross correlation index values corresponding to the predetermined frequency bins, and averaging the cross correlation index values to generate an average value; and
if a magnitude of the average value is less than a predetermined value, determining that the wind noise spectral content is present in the audio signals.

20. The method of claim 19, wherein acquiring the audio signals comprises acquiring time-domain signals from a microphone array.

21. The method of claim 19, wherein acquiring the audio signals comprises multiplying the audio signals by a selected window function.

22. The method of claim 19, wherein transforming the audio signals comprises applying a Discrete Fourier Transform to the acquired audio signals.

23. The method of claim 19, wherein selecting frequency bins corresponding to a predetermined frequency range comprises selecting frequency bins corresponding to a frequency range between approximately zero Hz and approximately 1000 Hz.

24. The method of claim 19, wherein averaging the cross correlation index values to generate an average value comprises generating an average value that ranges between approximately zero and approximately six.

25. The method of claim 19, wherein determining that the wind noise spectral content is present comprises determining that the average value ranges between approximately two and approximately four.

26. A method of detecting a wind noise spectral content in audio signals, comprising:
acquiring the audio signals;
transforming the audio signals;
decomposing the transformed audio signals to generate directional and non-directional components;
based upon a one or more of the generated directional and non-directional components, identifying discontinuous wind-noise spectral components; and
forming a continuous wind noise spectrum from the discontinuous wind-noise spectral components.

27. The method of claim 26, wherein decomposing the transformed audio signals comprises decomposing the transformed audio signals into A-format signals and B-format signals.

28. The method of claim 26, wherein forming a continuous wind noise spectrum comprises using a least squares algorithm to form the continuous wind noise spectrum from the discontinuous wind noise components.

29. The method of claim 26, wherein identifying discontinuous wind-noise spectral components comprises:
computing autocorrelations and cross correlations from the transformed audio signals;
computing a cross correlation index based upon the computed autocorrelations and cross correlations; and
if a magnitude of the cross correlation index is less than a predetermined value, determining that the wind noise spectral content is present in the audio signals.

30. The method of claim 26, wherein identifying discontinuous wind-noise spectral components comprises:
computing a power in a low frequency region of the acquired signals;
comparing the computed low frequency power to a predetermined threshold value; and
if a magnitude of the computed low frequency power is less than a predetermined value, determining that the wind noise spectral content is present in the audio signals.

31. The method of claim 26, wherein identifying discontinuous wind-noise spectral components comprises:
assembling the transformed signals into an array;
performing a linear regression on the transformed signals in the array to generate a slope;
comparing the slope to a predetermined threshold value; and
if a magnitude of the slope is less than a predetermined value, determining that the wind noise spectral content is present in the audio signals.

32. An apparatus for reducing wind noise spectral content in audio signals, comprising:
an audio processing unit configured to receive non-decomposed audio signals;
an audio decomposition unit configured to receive the non-decomposed audio signals from the audio processing unit and to generate decomposed audio signals;
a wind noise spectrum estimation unit configured to receive non-decomposed audio signals from the audio processing unit and to receive decomposed audio signals from the audio decomposition unit and operable to identify wind noise spectral components in at least one of the non-decomposed audio signals and the decomposed audio signals; and
a wind noise spectrum reduction unit configured to receive the wind noise spectral components identified by the wind noise spectrum estimation unit and to remove the wind noise spectral components from at least one of the non-decomposed audio signals and the decomposed audio signals.

33. The apparatus of claim 32, wherein the audio processing unit comprises a microphone array.

34. The apparatus of claim 32, wherein the audio processing unit comprises at least one of an analog-to digital (ND) converter, an audio amplifier and signal filtering and equalization circuits.

35. The apparatus of claim 32, wherein the audio decomposition unit is configured to receive A-format signals, and to generate B-format signals from the A-format signals.

36. The apparatus of claim 32, wherein the wind noise estimation unit is configured to transform the audio signals, compute autocorrelations and cross correlations from the audio signals, compute a cross correlation index based upon the computed autocorrelations and cross correlations, and to determine that the wind noise spectral content is present in the audio signals.

37. The apparatus of claim 32, wherein the wind noise estimation unit is configured to transform the audio signals, compute a power in a low frequency region of the transformed signals, compare the computed low frequency power to a predetermined threshold value, and determine that the wind noise spectral content is present in the audio signals.

38. The apparatus of claim 32, wherein the wind noise estimation unit is configured to transform the audio signals, assemble the transformed signals into an array, perform a linear regression on the transformed signals in the array to generate a slope, compare the slope to a predetermined threshold value, and determine that the wind noise spectral content is present in the audio signals.

39. The apparatus of claim 32, wherein the wind noise spectrum reduction unit is configured to apply a wind noise spectrum-dependent gain factor to at least one of the non-decomposed audio signals and the decomposed audio signals.

40. An apparatus for reducing wind noise spectral content in audio signals, comprising:
an audio processing unit configured to receive non-decomposed audio signals;
an audio decomposition unit configured to receive the non-decomposed audio signals from the audio processing unit and to generate decomposed audio signals;
a wind noise spectrum estimation unit configured to receive non-decomposed audio signals from the audio processing unit and to receive decomposed audio signals from the audio decomposition unit and operable to identify wind noise spectral components in at least one of the non-decomposed audio signals and the decomposed audio signals;
a wind noise spectrum reduction unit configured to receive the wind noise spectral components identified by the wind noise spectrum estimation unit and to remove the wind noise spectral components from at least one of the non-decomposed audio signals and the decomposed audio signals; and
a frequency domain cross correlation unit configured to receive non-decomposed audio signals from the audio processing unit and to compute autocorrelations and cross correlations and to communicate the autocorrelations and the cross correlations to the wind noise spectrum estimation unit and the wind noise spectrum reduction unit.

41. The apparatus of claim 40, wherein the audio processing unit comprises a microphone array.

42. The apparatus of claim 40, wherein the audio processing unit comprises at least one of an analog-to digital (ND) converter, an audio amplifier and signal filtering and equalization circuits.

43. The apparatus of claim 40, wherein the audio decomposition unit is configured to receive A-format signals, and to generate B-format signals from the A-format signals.

44. The apparatus of claim 40, wherein the frequency domain cross correlation unit is configured to transform the audio signals, compute a cross correlation index based upon the computed autocorrelations and cross correlations, and to determine that the wind noise spectral content is present in the audio signals.

45. The apparatus of claim 40, wherein the wind noise spectrum reduction unit is configured to apply a wind noise spectrum-dependent gain factor to at least one of the non-decomposed audio signals and the decomposed audio signals.

46. An apparatus for reducing a noise spectral content in audio signals, comprising:
an audio processing unit configured to receive non-decomposed audio signals;
an audio decomposition unit configured to receive the non-decomposed audio signals from the audio processing unit and to generate decomposed audio signals;
a noise spectrum estimation unit configured to receive non-decomposed audio signals from the audio processing unit and to receive decomposed audio signals from the audio decomposition unit and operable to identify noise spectral components in at least one of the non-decomposed audio signals and the decomposed audio signals;
a noise spectrum reduction unit configured to receive the noise spectral components identified by the wind noise spectrum estimation unit and to remove the noise spectral components from at least one of the non-decomposed audio signals and the decomposed audio signals; and
a frequency domain cross correlation unit configured to receive non-decomposed audio signals from the audio processing unit and to compute autocorrelations and cross correlations and to communicate the autocorrelations and the cross correlations to the noise spectrum estimation unit and the noise spectrum reduction unit.

47. The apparatus of claim 46, wherein the audio processing unit comprises a microphone array.

48. The apparatus of claim 46, wherein the audio processing unit comprises at least one of an analog-to digital (ND) converter, an audio amplifier and signal filtering and equalization circuits.

49. The apparatus of claim 46, wherein the audio decomposition unit is configured to receive A-format signals, and to generate B-format signals from the A-format signals.

50. The apparatus of claim 46, wherein the frequency domain cross correlation unit is configured to transform the audio signals, compute a cross correlation index based upon the computed autocorrelations and cross correlations, and to determine that the noise spectral content is present in the audio signals.

51. The apparatus of claim 46, wherein the wind noise spectrum reduction unit is configured to apply a wind noise spectrum-dependent gain factor to at least one of the non-decomposed audio signals and the decomposed audio signals.

52. The apparatus of claim 46, wherein the noise spectral components include wind noise spectral components, electronic noise spectral components, and background noise spectral components.

53. An apparatus for reducing wind noise spectral content in audio signals, comprising:
an audio processing unit including a microphone array and configured to receive non-decomposed audio signals;
an audio decomposition unit configured to receive the non-decomposed audio signals from the audio processing unit and to generate decomposed audio signals;
a directional unit coupled to the audio decomposition unit and configured to determine directional information based upon the decomposed audio signals; and
a beamforming unit coupled to the directional unit and the audio processing unit to receive the non-decomposed audio signals and the directional information to configure the array to receive audio signals from a preferential direction.

54. The apparatus of claim 53, wherein the audio processing unit comprises at least one of an analog-to digital (ND) converter, an audio amplifier and signal filtering and equalization circuits.

55. The apparatus of claim 53, wherein the audio decomposition unit is configured to receive A-format signals, and to generate B-format signals from the A-format signals.

56. A method of spectral subtraction, comprising:
computing a logical conditional variable;
if the logical conditional variable has a first logical value, then a first gain value is used for spectral subtraction; and
if the logical conditional variable has a second logical value not equivalent to the first logical value, then a second gain value is used for the spectral subtraction.

57. The method of claim 56, wherein the first gain value and the second gain value include a ratio of the input spectral content divided by the noise spectral estimate.

58. The method of claim 57, wherein if the logical conditional variable is TRUE, then the first gain value equals one minus the ratio.

59. The method of claim 57, wherein if the logical conditional variable is FALSE, then the second gain value equals the ratio.
